(19) United States
(12) Patent Application Publication
(10) Pub. No.: US 2025/0172508 A1
(43) Pub. Date: May 29, 2025

(54) Digitally Addressable Sample Irradiator

(71) Applicants: Mark Eaton; Nalin Kumar; Ronald Hellmer; Shuo Cheng

(72) Inventors: Mark Eaton; Nalin Kumar; Ronald Hellmer; Shuo Cheng

(73) Assignee: Stellarray, Incorporated, Austin, TX (US)

(21) Appl. No.: 18/518,930

(22) Filed: Nov. 24, 2023

(51) Int. Cl. G01N 23/04; H01J 35/06; H01J 35/14

(52) U.S. Cl. CPC G01N 23/04; H01J 35/06; H01J 35/14; G01N 2223/206; G01N 2223/64

(57) ABSTRACT

This invention provides a multi-spot, digitally-addressable X-ray source operable so as to emit X-ray flux from separate spots in the source to separate, defined samples or sample areas outside the source. The x-ray flux maybe used for irradiation or for imaging. The source may be configured with reflective, transmission or forward flux channel anodes. A system made using this source comprises the source itself, a power supply, controls and cooling system for the source, a means to locate the sample array on or near the source and a radiation shielded cabinet. One or more x-ray detectors for measuring dose intensity or for imaging may be included in the system.

### PRIORITY DATA

This application claims the benefits of provisional filing 62/537,936, Digitally Addressable Sample Irradiator, on Jul. 27, 2017.

### FEDERALLY FUNDED RESEARCH

Parts of this invention were funded by the U.S. Department of Energy under Grant No. DE-SC13867. The U.S. Government has certain rights in this invention.

### TECHNICAL FIELD OF THE INVENTION

This invention relates in general to the field of sample irradiation and imaging systems and more particularly to a sample irradiation and imaging system in which a multiplicity of separately addressable x-ray spots on an anode may be generated inside of the vacuum enclosure of one x-ray flux source, with the flux from each x-ray spot directed to a particular sample in an array of samples.

### BACKGROUND OF THE INVENTION

This invention provides a single, stationary, multi-spot source of x-ray flux in which the flux from individual spots on an anode, generated by individual electron beams from corresponding cathodes in a cathode array, are directed at a particular samples in an array of samples. The x-ray flux may be used for irradiation, for example in radiobiology or radiochemistry studies, or for imaging, for example in biopsy imaging, or in combinations of irradiation and imaging. The cathode array and the anode or anode array are enclosed in or are an integral part of the vacuum envelope of the source. They are disposed opposite each other in the source, so that electron beams from the cathodes in the cathode array may be accelerated across the vacuum between them and thereby generate x-rays on the metallic anode. Multiple x-ray flux beams of the source may also be used for tomographic imaging of one or more samples. The x-ray source of the present invention is combined with a high voltage power supply, electronic circuits to control the emission current from the cathodes in the cathode array, a radiation shielded cabinet and a means to introduce samples into the x-ray radiation field, to form the irradiator of the present invention. An x-ray detector or detector array may be included so as to allow the formation of radiographic images of the samples in the sample array.

Sample irradiation. Various types of chemical or biological samples are irradiated in gamma and x-ray research irradiators to determine the effects of ionizing radiation on those samples, for a wide range of research objectives. The irradiators generally use either electrical x-ray sources or isotope sources for the radiative flux. Single samples or multiple samples may be placed in the irradiator, but they will all receive the same kind of x-ray flux and the same dose from the single, or in some cases double, sources of flux. Prior art x-ray irradiators are unable to discriminate between the samples in an array or multiplicity of samples and deliver different doses or energy spectra to each. This makes prior art irradiators unable to use the vast infrastructure that has grown up around microwell plates and other sample handling appliances that are now commonly used for biological and chemical research. The ability to deliver different doses and energies to different samples in an array would increase the efficiency and scope of this kind of research.

One prior art irradiation system (U.S. Pat. No. 7,220,971) teaches the uses of multiple cathodes in a cathode array to irradiate samples with electron beams, but this system does not provide for controllable irradiation by x-rays from an anode. More recently, Fowler et al in “A novel high-throughput irradiator for in vitro radiation sensitivity bioassays”, Phys Med Biol. 2014 Mar. 21; 59 (6): 1459-1470 and Folwer et al in “Biological characterization of a novel in vitro cell irradiator” PLOS ONE 12 (12): e0189494, disclose an x-ray sample irradiation system in which individual cells in a microwell plate are irradiated by a micro-focus x-ray tube moved by means of a mechanical gantry underneath the microwell plate. The power obtainable form such sources is limited, extra time is required to move the source from well to well and it is difficult to isolate the x-ray flux beam to individual wells.

Sample imaging. Other devices known in the art are used to image biological chemical, mineral or device samples using x-rays. Some of these devices, for example, are used for imaging of biopsy samples. These prior art devices use point sources of x-rays, most commonly the traditional x-ray tube. Due to the reliance on a single spot or point source of x-rays these devices are unable to image multiple samples in a sample array or to vary the x-ray flux intensity and spectra between the samples. They also are unable to perform tomographic imaging. Micro CT machines can perform tomographic imaging, but they are expensive and can image only one sample at a time.

The need therefore exists for a system in which multiple samples can be irradiated imaged at once or in rapid succession, and at different x-ray exposure parameters (voltage, current, duration and x-ray energy spectrum).

### OBJECTS AND ADVANTAGES OF THE INVENTION

It is an object of this invention to digitally address separate spots in a single x-ray source so as to irradiate or image separate samples in an array of samples. Another object is to allow variation in the x-ray flux intensity and energy so as to increase the experimental or diagnostic variation in the sample array. A further object is to increase the speed and efficiency of irradiation or imaging studies. A yet further object is to enable efficient and inexpensive tomographic imaging of single or multiple samples in an array.

### SUMMARY OF THE INVENTION

This invention provides a multi-spot, digitally-addressable X-ray source operable so as to emit X-ray flux from separate spots in the source to separate, defined samples or sample areas outside the source. The x-ray flux maybe used for irradiation or for imaging. The source may be configured with reflective or transmission anodes or with the forward flux channel anode as taught in U.S. Pat. No. 9,508,523. A system made using this source comprises the source itself, a power supply, controls and cooling system for the source, a means to locate the sample array on or near the source and a radiation shielded cabinet. One or more x-ray detectors for measuring dose intensity or for imaging may be included in the system.

### BRIEF DESCRIPTIONS OF THE DRAWINGS

The attached drawings are provided to help describe the structure, operation, and some embodiments of the source of the present invention. Numerous other designs, methods of operation and applications are within the meaning and scope of the invention.

FIG. 1 shows a source of the present invention with a reflective x-ray anode used to deliver separate, collimated x-ray flux beams to separate wells in a microwell plate.

FIG. 2 shows a cross-sectional view of an embodiment of the multi-spot source in which the electron emitter array is comprised of three separate plates for cathode, gate and focus sections.

FIG. 3 shows the operation of an individual section of the source to direct x-ray flux to an individual sample.

FIG. 4 shows another embodiment the source in which the cathode array is clad by a symmetrical gate structure.

FIG. 5 shows a top-down view of the source with apertures in the source top plate which allow collimated flux beams to be directed to individual samples cells, in this case the separate wells of a microwell plate.

FIG. 6 shows an irradiation system using the source of the present invention.

FIG. 7 shows another embodiment of the source of the present invention using a transmission x-ray target with a cathode array disposed beneath the target.

FIG. 8 shows the source of the present invention in a sample imaging application with a transmission x-ray target.

### DETAILED DESCRIPTION OF THE INVENTION

Although the following detailed description delineates specific attributes of the invention and describes specific designs and fabrication procedures, those skilled in the arts of radiographic imaging or radiation source production will realize that many variations and alterations in the fabrication details and the basic structures are possible without departing from the generality of the processes and structures.

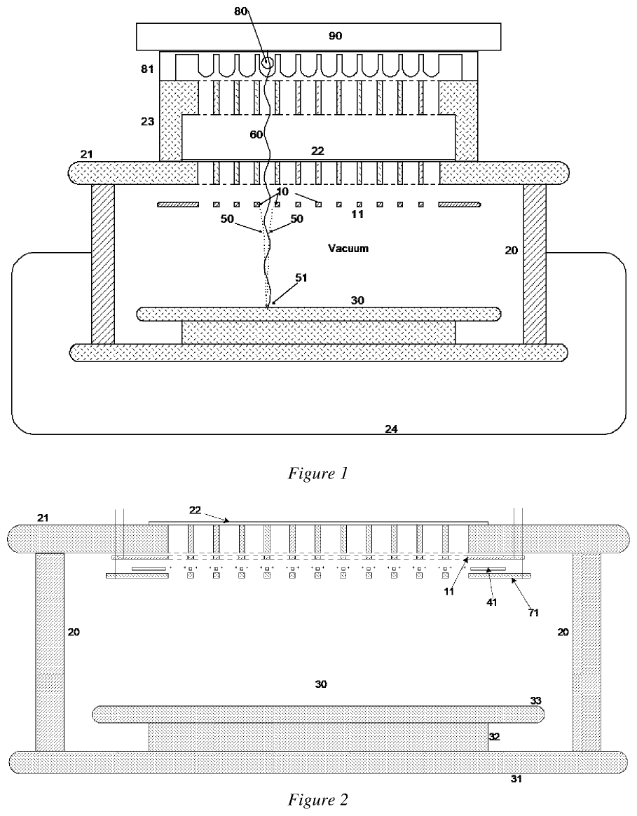

Operation. The source of the present invention operates by the emission of separate e-beams from separate cathodes in an array to corresponding locations on one or more X-ray anodes in the source. The e-beams are accelerated at high-voltage across the vacuum of the source to hit separate spots on the anode. The x-ray flux from the separate spots 51 on the anode is directed to separate samples in the sample array. In FIG. 1 an embodiment using a reflective type anode 30 is shown. In this case, x-ray flux 60 passes through apertures in the e-beam emitter section 100, then through corresponding apertures in metal top plate 21 for the vacuum source, then through an X-ray transparent window 22, and then through apertures in an additional metal flux collimating structure 23, and then to an individual well 80 in a microwell plate 81. A common microwell plate has 96 wells in an 8×12 format. The wells can be irradiated singly, in succession, in groups, or all at once. The separate cathodes 10 in cathode array 11 can be operated at different accelerating voltages, different current intensities, and for different durations, so as to vary the x-ray flux impinging on the separate wells of the microwell plate. Collimation is provided by the apertures in the emitter section, the apertures in the top plate and the apertures in the optional additional collimating structure. In the configuration shown in FIG. 1, the vacuum needed for X-ray generation is provided by a package comprising top plate 21 and window 22, glass, ceramic or other insulating sidewalls 20 and an anode baseplate 31. The anode 30 may further comprise a multi-plate structure in which a metallic top anode plate 33 which receives the electron beam impact is disposed on top of a raising block 32 so as not to touch the insulating sidewalls 20 and create vacuum triple points. The upper surface of top anode plate 33 may be comprised of separate sections each with a different metal for generating x-rays with particular energies, thereby allowing variation of the energy spectrum of the x-rays delivered to the separate samples in the sample array. The separate metal sections may be formed by brazing, deposition processes such as sputtering or mechanical attachment to a common metal plate.

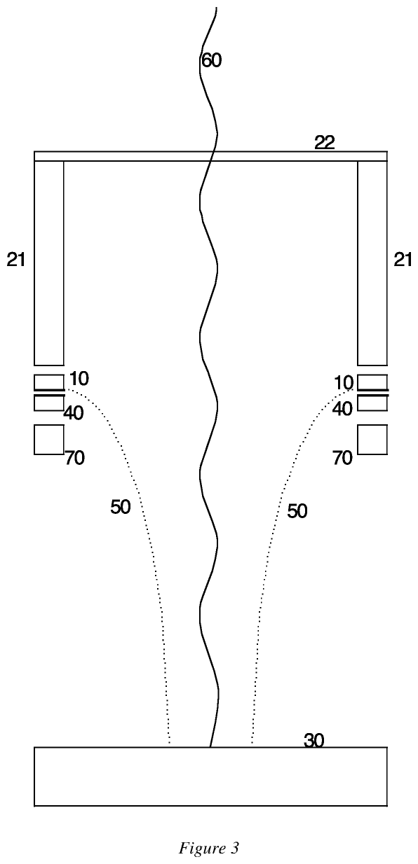

FIG. 2 provides more detail on the construction of the emitter section of the source. In this embodiment, the emitter section comprises a cathode plate 12 supporting a field emission cold cathode array, a gate plate 41 underneath the cathode plate with aperture style gates 40 used to extract emission current from the cathodes, and a focus plate 71 with apertures 70 that focus the electron beam 50 from the cathodes onto the spots on the anode. Cathodes 10 in cathode array 11 may be addressed by separate conducting lines running perpendicular to separate conducting lines on the gate plate, so the individual cathodes may be addressed in a matrix array format. FIG. 3 shows a cross-sectional view of an individual emitter cell, in this case an annular emitter structure designed so as not to block or impede x-rays from the anode on their way through window 22 and then the sample. An annular thin-film edge emitter field emission cathode 10 is disposed on cathode plate 12. An annular thin-film field emission gate is disposed on gate plate 41. An electrical potential between the cathode and gate induces field emission current from the cathode, which is emitted into the annular opening of the cathode and then attracted by the field between the emitter section and the high potential anode. The annular electron beam thus formed is focused further by the electrical field of annular focus element 70, which is part of focus plate 71. The electron beam 50 impacts anode 30 at high energy thereby generating x-rays in all directions. A columnar beam of the generated x-rays will pass through the apertures in the emitter section and the source top plate, through the window of the source and collimating metal plate on top of the window, and then on to the sample.

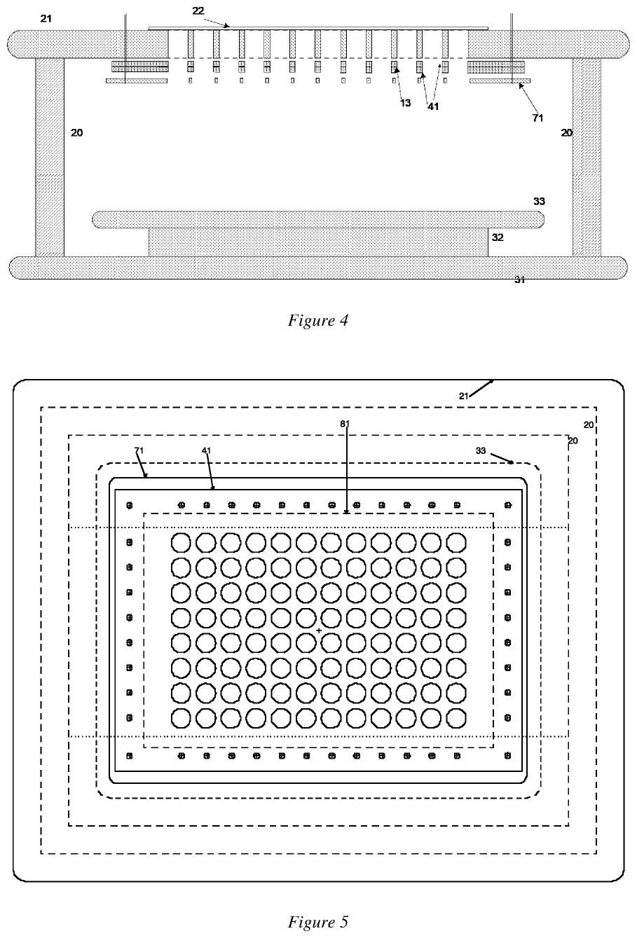

In FIG. 4, another embodiment of the middle section is shown in which the cathode lines are sandwiched between upper and lower insulating gate plates 41. Perpendicular lines on the top and bottom gate plates are used to address individual cathodes in the array. The cathodes are disposed on a thin foil of metal 13, which may be cut into strips with the edge emitter apertures running along their length. This configuration provides a symmetrical extraction gate for the cathodes and enhances the efficiency of field emission.

FIG. 5 shows an overlay top-down view of the positioning of the various plates in an embodiment of the x-ray source of the present invention with a reflective anode, with the apertures in the top plate 21, gate plates 41 and focus plate 71 all aligned so as to pass the x-ray flux from anode 30 unimpeded to the individual wells of microwell plate 81.

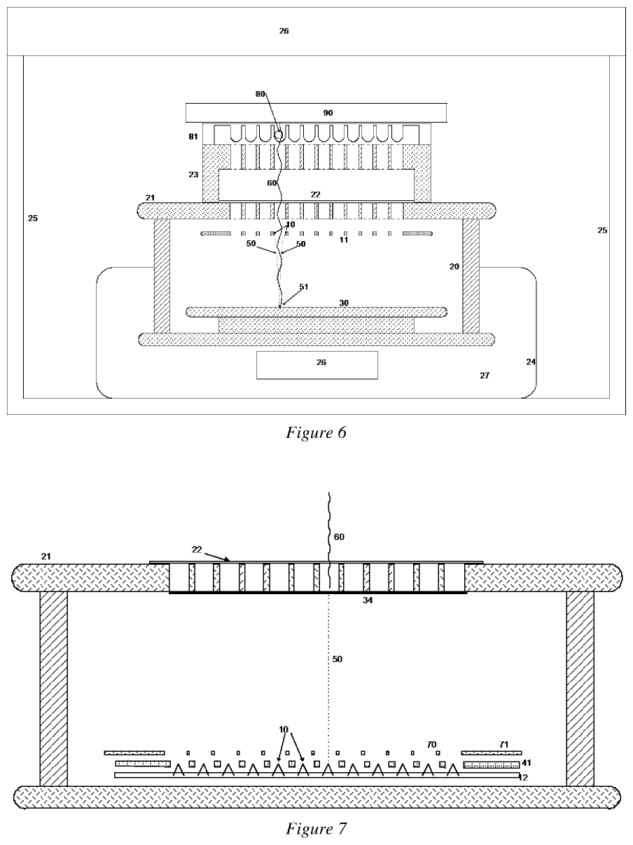

In FIG. 6, an embodiment of a full system is shown. A high-voltage amplifier 26 is disposed underneath the anode baseplate 31 so as to minimize the distance between the amplifier and the anode, thereby making the system compact. An insulating casing 24 holds electrical insulation medium 27, which is preferably comprised of materials with high thermal conductivity, such as ceramic potting materials, or ceramic powders mixed in with epoxy or silicone. Alternatively, fluid cooling media such as insulating oil may be circulated from casing 24 to heat exchangers to conduct heat away from anode 30. Radiation-shielded cabinet 25 with a shielded lid 26 allows the operator to open and close the cabinet and change out microwell plates or other sample arrays. An x-ray detector array 90 can optionally be placed above the sample array so as to record the precise dose delivered to each of the samples.

FIG. 7 shows an embodiment of the source of the present invention in which a transmission X-ray target 34 is used. In this embodiment the electron emitter array 100 is disposed underneath the thin film x-ray target. X-rays are generated on the thin-film target and exit the top of the source. The transmission X-ray target may be attached to the metal top plate 21 with apertures 22 as shown in the Figure, but numerous other embodiments may be used for transmission target x-ray generation. Forward flux channel X-ray targets may also be used.

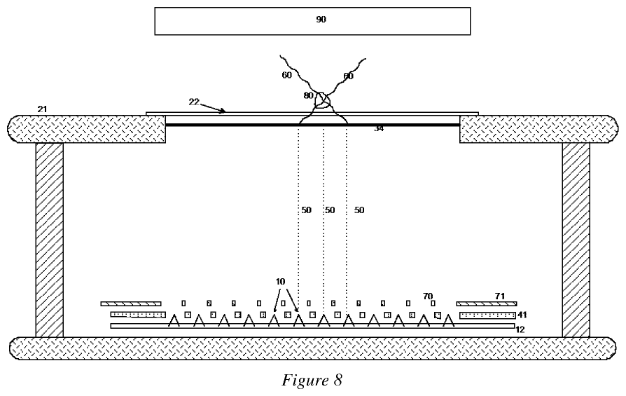

Imaging may be performed on samples using a number of different embodiments of the source of the present invention. One such an embodiment is shown in FIG. 8, in which a sample 80 is placed on top of a top glass plate 22 at the top of the source. Thin-film X-ray anode target 34 is disposed underneath this top exit window. E-beams from separate cathodes in the cathode array are emitted towards the target and focused to generate x-rays at separate spots on the target. The x-rays passed through the sample and are detected at one or more x-ray detectors above the sample. The source can be operated at any of the voltages and current levels used in medical, industrial or research imaging configurations.

Tomographic imaging of samples may be performed by generating x-rays at multiple spots on the anode in sequential or multiplexed formats. This allows tomosynthetic reconstruction of 3-D images of samples. Multiple samples maybe placed on the top glass, directly or in sample holders, for tomographic imaging of all the samples in the array. An exemplary application of tomographic imaging is breast biopsy samples. The ability to obtain rapid and multiple 3-D images of biopsy samples will increase the accuracy of this procedure, since 3-D images are better able to reveal calcifications and other indicators of tumors. An alternative embodiment of a thin film target X-ray source uses cups in the thin-film x-ray target into which biopsies or other samples are placed, with x-rays generated at different locations on the cups to obtain 3-D images.

The source of the present invention may be used for other types of x-ray analysis, such as x-ray florescence.

There are a number of cathode choices for the cathodes in the array of the source, including cold cathode field emitters, thermal filament emitters, dispenser cathodes or any other cathode which will fit into the array. Exemplary cold cathodes include lateral thin film edge emitters, which may be made of various, materials, including carbon, layered films of different forms of carbon, carbon nanotubes or graphene, layered films of metal, layered films of metal and carbon, etc. Current from the cathodes in the array may be stabilized by the incorporation of resistors for individual emitters or areas. The cathodes in the array may also be gated, so as to allow extraction of current from the cathodes at lower voltages. Gates and focusing elements, such as electrostatic lenses, may be provided so as to direct the e-beams in an optimal direction. Another exemplary cold cathode for an array is a disk pusher cathode, in which a large number of individual cold cathode tips face inwards towards a circular pusher electrode, which defines the spot size of the e-beam and directs the electrons up off the cathode substrate and towards the anode. The pusher electrode may be biased so as to focus the beam and this focusing may be used in conjunction with other focusing elements. The beam shape is annular. Another cold cathode choice, for very tight annular beams, is to deposit large numbers of thin films of alternative insulating and conductive/emissive materials, such as diamond and Mo, around very thin wires, which are rotated in the deposition chamber. The wires are then cut into small sections to provide an annular metal-insulator-metal cold cathode which has proven to yield high, stable current levels. These cathodes will have a small enough profile to allow their placement in the middle of the annular openings in the emitter section and still not attenuate a significant portion of the x-ray flux.

The present invention is well adapted to carry out the objects and attain the ends and advantages described as well as others inherent therein. While the present embodiments of the invention have been given for the purpose of disclosure numerous changes or alterations in the details of construction and steps of the method will be apparent to those skilled in the art and which are encompassed within the spirit and scope of the invention.

What is claimed is:

1. A multi-spot, digitally-addressable X-ray source operable so as to emit X-ray flux from separate spots in the source to separate samples in an array of samples outside the source, the source comprising a cathode array in which individual cathodes emit electron beams which are accelerated across a vacuum space to impact corresponding spots on an x-ray anode disposed opposite the cathode array.

2. A system using the source of claim 1 in which the separate samples in the sample array are irradiated to determine the chemical or biological effects of the radiation.

3. A system using the source of claim 1 in which the separate samples in the sample array are contained in a microwell plate.

4. A system using the source of claim 1 in conjunction with an x-ray detector disposed beyond the samples so as to image the samples.

5. The source of claim 1 in which the anode is a reflective anode, with the cathodes in the cathode array disposed between the anode and the sample array.

6. The source of claim 1 in which the anode is a transmission anode, with the anode disposed between the cathode array and the sample array.

7. The source of claim 1 in which the anode or part of the anode forms an integral art of the vacuum enclosure of the source.

8. A source of claim 1 in which the cathodes, gates and focusing elements are disposed on plates with openings that allow the x-ray flux from an individual spot on the anode to pass through unimpeded and undistorted on its way to irradiate or image the sample.

9. The system of claim 2 in which the x-ray beams from the anode are addressed sequentially.

10. The system of claim 2 in which one or more x-rays beams from the anode are addressed simultaneously.

11. The source of claim 1 in which different individual spots on the anode are addressed with electron beams having different voltage, current or impact duration, so as to vary the energy, dose or intensity of the x-ray flux.

12. The source of claim 1 in which separate areas of the electron impact surface of the anode are comprised of different metals, so as to generate different x-ray spectra.
